(19) United States
(12) Patent Application Publication
(10) Pub. No.: US 2026/0169848 A1
(43) Pub. Date: Jun. 18, 2026

(54) METHOD TO DYNAMICALLY REDUCE FIRST FAILURE DATA CAPTURE RESOURCE CONSUMPTION

(71) Applicant: INTERNATIONAL BUSINESS MACHINES CORPORATION, ARMONK, NY (US)

(72) Inventors: BRETT D'ARCO, WHITE PLAINS, NY (US); MICHAEL E. GILDEIN, WAPPINGERS FALLS, NY (US); CALISTA ASHLEY PHIPPEN, POUGHKEEPSIE, NY (US); SCOTT SIGALAS, CLINTONDALE, NY (US)

(21) Appl. No.: 18/980,298

(22) Filed: Dec. 13, 2024

(51) Int. Cl. G06F 11/07; G06F 11/30

(52) U.S. Cl. CPC G06F 11/079; G06F 11/3034; G06F 11/3072; G06F 2201/81

(57) ABSTRACT

Dynamically reducing FFDC resource consumption includes: identifying an FFDC runaway condition in a computing system, analyzing multiple FFDC artifacts associated with the FFDC runaway condition, including identifying a set of potential causing elements, where the set of potential causing elements include multiple elements potentially responsible for causing the FFDC runaway condition, determining, from the set of potential causing elements, one or more actual causing elements responsible for causing the FFDC runaway condition, and performing, on the one or more actual causing elements, one or more actions to address current FFDC runaway conditions.

### BACKGROUND

### Field of the Disclosure

The field of the disclosure is data processing, or, more specifically, methods, systems, and products for dynamically reducing first failure data capture (FFDC) resource consumption.

### Description of Related Art

Enterprise computing systems and applications often have automatic first failure data capture (FFDC) technology to gather system and/or application data in the event of a failure or fault. This FFDC collection may include the collection of various FFDC artifacts, such as logs, trace, memory dumps, and other artifacts. Situations can arise where certain errors and failure events drive repeating FFDC artifacts to be collected, as well as causing additional elements to fail, thus increasing the rate of continual FFDC artifact collection. In the event of such an FFDC runaway condition, a system will continuously produce FFDC artifacts, thereby consuming a large amount of resources and diverting resources from current critical production workloads and limiting availability for imminent FFDC needs.

### SUMMARY

Methods, apparatus, and systems for dynamically reducing FFDC resource consumption according to various embodiments are disclosed in this specification. In accordance with one aspect of the present disclosure, a method of dynamically reducing FFDC resource consumption includes identifying an FFDC runaway condition in a computing system, analyzing multiple FFDC artifacts associated with the FFDC runaway condition, including identifying a set of potential causing elements, where the set of potential causing elements include multiple elements potentially responsible for causing the FFDC runaway condition, determining, from the set of potential causing elements, one or more actual causing elements responsible for causing the FFDC runaway condition, and performing, on the one or more actual causing elements, one or more actions to address current FFDC runaway conditions.

In accordance with another aspect of the present disclosure, a system for dynamically reducing FFDC resource consumption may include a disk storage configured for storing FFDC artifacts, one or more subsystems configured to store FFDC artifacts in the disk storage, and a processor configured to monitor the disk storage, where the processor is configured to: identify an FFDC runaway condition, analyze multiple FFDC artifacts stored in the disk storage and associated with the FFDC runaway condition, including identifying a set of potential causing elements, where the set of potential causing elements include multiple elements potentially responsible for causing the FFDC runaway condition, determine, from the set of potential causing elements, one or more actual causing elements responsible for causing the FFDC runaway condition, and perform, on the one or more actual causing elements, one or more actions to address current FFDC runaway conditions.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 is a block diagram of an example system configured for dynamically reducing FFDC resource consumption in accordance with embodiments of the present disclosure.

FIG. 2 is a block diagram of an example computing environment configured for dynamically reducing FFDC resource consumption according to some embodiments of the present disclosure.

FIG. 3 is a flowchart of an example method for dynamically reducing FFDC resource consumption according to some embodiments of the present disclosure.

FIG. 4 is a flowchart of another example method for dynamically reducing FFDC resource consumption according to some embodiments of the present disclosure.

FIG. 5 is a flowchart of another example method for dynamically reducing FFDC resource consumption according to some embodiments of the present disclosure.

### DETAILED DESCRIPTION

In accordance with one aspect of the present disclosure, a method of dynamically reducing FFDC resource consumption includes identifying an FFDC runaway condition in a computing system, analyzing multiple FFDC artifacts associated with the FFDC runaway condition, including identifying a set of potential causing elements, where the set of potential causing elements include multiple elements potentially responsible for causing the FFDC runaway condition, determining, from the set of potential causing elements, one or more actual causing elements responsible for causing the FFDC runaway condition, and performing, on the one or more actual causing elements, one or more actions to address current FFDC runaway conditions. Such an embodiment allows for the detection of an FFDC runaway condition and stopping it before it continues to rapidly consume additional resources.

In another embodiment, identifying the FFDC runaway condition includes monitoring the computing system and determining that a rate of FFDC artifact storage has increased above a threshold. Such an embodiment provides for a method for accurately detecting the FFDC runaway condition based on the monitoring of the system and based on a comparison of the current status of the system with predetermined thresholds.

In another embodiment, analyzing the plurality of FFDC artifacts associated with the FFDC runaway condition includes filtering out one or more of the plurality of FFDC artifacts based on one or more criteria. Such an embodiment provides for increased efficiency when determining the potential causing elements by filtering out unnecessary FFDC artifacts.

In another embodiment, the one or more criteria includes at least one of: an error severity level, an associated subsystem, or an associated workload being executed. Such an embodiment allows for various methods for filtering out FFDC artifacts, allowing for flexibility or customization.

In another embodiment, analyzing the plurality of FFDC artifacts associated with the FFDC runaway condition is carried out by one of a machine learning model or an artificial intelligence model. Such an embodiment allows for automatic and intelligent analysis of the FFDC artifacts when determining which elements may be responsible for the FFDC runaway condition.

In another embodiment, the method further includes, responsive to identifying the set of potential causing elements, ordering the set of potential causing elements based on one or more of: a number of error counts, or an error severity level. Such an embodiment provides for the identified elements to be sorted based on likelihood of responsibility for the condition, which will ultimately increase efficiency when performing the method as a whole.

In another embodiment, determining the one or more actual causing elements includes disrupting each of the set of potential causing elements and comparing an associated FFDC artifact with one or more of the plurality of FFDC artifacts. Such an embodiment provides a method for confirming which elements actually helped to cause the condition.

In another embodiment, disrupting each of the set of potential causing elements is performed serially based on an ordering of the set of potential causing elements. Such an embodiment allows for increased efficiency when confirming which potential elements actually are responsible, by checking each element based on an order of likelihood or a confidence level.

In another embodiment, the one or more actions to address current FFDC runaway conditions are performed, based on referencing a policy, automatically by the computing system. Such an embodiment provides a method of addressing the FFDC runaway condition automatically without user input, allowing for increased efficiency and speed when addressing and correcting such conditions.

In another embodiment, performing the one or more actions includes sending a notification to a user and performing the one or more actions responsive to receiving, from the user, a response to the notification. Such an embodiment provides a mechanism for performing corrective actions based on user input, allowing for more care and customization during the process.

In another embodiment, the method further includes cleaning up the plurality of FFDC artifacts associated with the FFDC runaway condition. Such an embodiment provides for the reduction of consumed resources associated with a FFDC runaway condition.

In accordance with another aspect of the present disclosure, a system for dynamically reducing FFDC resource consumption includes a disk storage configured for storing FFDC artifacts, one or more subsystems configured to store FFDC artifacts in the disk storage, and a processor configured to monitor the disk storage, where the processor is configured to: identify an FFDC runaway condition, analyze multiple FFDC artifacts stored in the disk storage and associated with the FFDC runaway condition, including identifying a set of potential causing elements, where the set of potential causing elements include multiple elements potentially responsible for causing the FFDC runaway condition, determine, from the set of potential causing elements, one or more actual causing elements responsible for causing the FFDC runaway condition, and perform, on the one or more actual causing elements, one or more actions to address current FFDC runaway conditions. Such an embodiment allows for the detection of an FFDC runaway condition and stopping the condition before the condition continues to rapidly consume additional resources.

In accordance with another aspect of the present disclosure, a computer program product for dynamically reducing FFDC resource consumption includes a computer readable storage medium and computer program instructions stored therein that, when executed, are configured to: identify an FFDC runaway condition, analyze multiple FFDC artifacts stored in the disk storage and associated with the FFDC runaway condition, including identifying a set of potential causing elements, where the set of potential causing elements include multiple elements potentially responsible for causing the FFDC runaway condition, determine, from the set of potential causing elements, one or more actual causing elements responsible for causing the FFDC runaway condition, and perform, on the one or more actual causing elements, one or more actions to address current FFDC runaway conditions. Such an embodiment allows for the detection of an FFDC runaway condition and stopping the condition before the condition continues to rapidly consume additional resources.

FFDC, or First Failure Data Capture, is a technology used in computing systems and applications that allows for systems to gather and store system and/or application data in the event of a failure or fault. The data stored responsive to a failure or fault is referred to as FFDC artifacts, where each FFDC artifact is associated with a particular computing component, system, subsystem, or application and includes data corresponding with a given fault or failure. FFDC artifacts may include logs, trace, memory dumps, and other similar artifacts. In some embodiments, certain errors and failure events can cause repeating FFDC artifacts to be collected (referred to herein as an FFDC runaway condition). In conventional systems, basic limited suppression may be in place to reduce duplication of FFDC by recognizing exact text matches on titles and other attributes. However, these de-duplication efforts may be insufficient when similar artifacts originate from different systems or contain text-based titles such as timestamps. In such an embodiment, where a system is experiencing an FFDC runaway condition, the system will continuously produce FFDC artifacts (e.g., address space dumps or other similar artifacts). However, storing such FFDC artifacts requires significant resources to process and store, which in turn diverts resources from current critical production workloads and limits availability for imminent FFDC needs. In conventional systems, a system admin must identify these situations manually, such as by noticing the space allocated to dumps is low or dumps are failing due to insufficient resources. Further, correcting such system conditions requires manual corrective actions (for example, a system programmer may look at the dumps being produced and determine if the occurrences are duplicated and subsequently remove any redundancies). In some embodiments, FFDC artifacts stored responsive to an FFDC runaway condition, as well as the associated components or subsystems, may be difficult to isolate or identify. For example, FFDC artifacts may be captured from any components or subsystems experiencing faults, including tightly coupled components as well as other components having dependencies on the component experiencing issues. This can introduce significant debugging efforts to isolate contributing components. The remaining disclosure provides systems and methods for identifying, stopping, and preventing FFDC runaway conditions, as well as dynamically reducing FFDC resource consumption. The embodiments of the present disclosure may be carried out in parallel with other existing deduplication methods for reducing FFDC resource consumption.

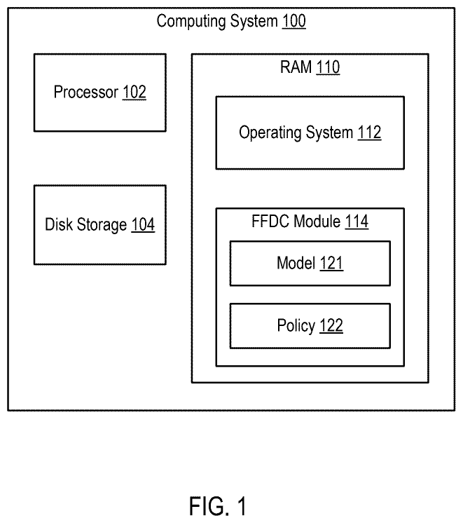

Exemplary methods, systems, and products for dynamically reducing FFDC resource consumption in accordance with the present disclosure are described with reference to the accompanying drawings, beginning with FIG. 1. FIG. 1 sets forth a block diagram of an example system configured for dynamically reducing FFDC resource consumption in accordance with embodiments of the present disclosure. The example of FIG. 1 includes computing system 100, which includes processor 102, disk storage 104, and RAM (Random Access Memory) 110. In the example computing system 100 of FIG. 1, example RAM 110 includes operating system 112 and FFDC module 114. In the example system of FIG. 1, the FFDC module 114 includes a model 121 and a policy 122.

The example FFDC module is configured to carry out the various embodiments of the present disclosure. The example model 121 may be a machine learning model or may be an artificial intelligence model. In some embodiments, the FFDC module may include multiple models. The example policy 122 includes information and instructions for carrying out the various embodiments of the present disclosure. In some embodiments, the policy is configured to be updated (either by user input or by model 121) based on previous performance and feedback responsive to actions taken.

The example disk storage 104 is configured to store FFDC artifacts. The example disk storage 104 is configured to store FFDC artifacts for any given component, subsystem, or application associated with computing system 100. In an embodiment where computing system includes a group of other computing systems, disk storage is configured to store FFDC artifacts associated with any included computing system.

The example computing system 100 of FIG. 1 is configured to identify an FFDC runaway condition by monitoring the system and the disk storage 104, and by determining when one or more FFDC artifact creation counts or storage rates exceed a custom threshold and/or a correlation exists between FFDC artifact attributes. The computing system 100 is also configured to perform analysis on the set of captured FFDC artifacts to determine the likelihood that each involved element (e.g., component, process, or address space) could be the source of the runaway condition in the system or subsystem (referred to as a potential causing element). Once determining such a set of potential causing elements, the set may be ordered according to one or more attributes, such as a number of error counts, an error severity level, and the like. In some embodiments, user input may be used to contribute to this ordering of the set of potential causing elements, such as based on the component's necessity to the system and/or workload. For example, components essential to an important executing workload may be ordered so as to not interfere with those components and, in turn, the workload. In some embodiments, machine learning and/or artificial intelligence models (e.g. model 121) may be employed by computing system 100 to help in such determinations of the set of potential causing elements.

The example computing system 100 of FIG. 1 is also configured to serially (according to the order of the set) disrupt each potential causing element (e.g., component, process, or address space) from most likely to least likely, to determine if the disruption has caused a statistically significant change in artifact creation, thereby verifying whether the potential causing elements are actually the cause of the runaway condition, as predicted. That is, by interrupting, or temporarily halting, the element, the system may confirm if a potential causing element is an actual causing element (that is confirmed to be responsible, or partially responsible, for causing the FFDC runaway condition) by observing whether the disruption had an impact on the runaway condition (e.g., if the storage rate of FFDC artifacts has decreased responsive to the disruption). When such a change is observed, it can be ascertained that the element in question is an actual causing element that is contributing to causing the system to experience the abnormality or FFDC runaway condition. In some embodiments, the disruption may include restarting the element (such as a subsystem), or causing a delay.

In one embodiment, the element is disrupted multiple times periodically to confirm that the disruption of the element positively impacts the runaway condition (such as decreasing the rate of FFDC artifacts being stored in disk storage). In one embodiment, multiple elements may be disrupted in parallel (i.e., simultaneously). In one embodiment, serially disrupting the potential causing elements is carried out until all of the potential causing elements in the set have been disrupted. In another embodiment, serially disrupting the potential causing elements is carried out only until a previously determined number of actual causing elements have been confirmed, or until a predetermined percentage of the FFDC runaway condition has been affected or stopped. For example, the system may continue to determine actual causing elements until 95% of the FFDC artifact creation associated with the FFDC runaway condition has had associated elements identified as actual causing elements. In such an example, the system only needs to identify the main causes of the runaway condition in order to stop the runaway condition from continuing. In one embodiment, the system is configured to skip over (and thereby prevent disrupting) an element if it is critical to a particular workload or application. Such elements may be determined based on the policy 122.

The example computing system 100 of FIG. 1 is also configured to, upon determining the actual causing elements, perform one or more corrective actions. In one embodiment, the correct actions are performed on one or more of the identified actual causing elements. In one embodiment, user controlled policies (such as policy 122) are used to determine the course of action when a given element is determined to be the actual cause. In another embodiment, the course of action may include prompting a user for user input before carrying out one or more of the corrective actions. For example, a system admin may be notified of one or more corrective actions to be performed that require user approval before carrying out the actions. In one embodiment, a policy may determine whether user input is required for a particular action based on previous user input or based on the model (e.g., model 121) determining that the action could be disruptive to the system or workload or application. In such an embodiment, the policy may specify that a system admin, or other user, will need to approve the action in question before carrying out the action. In some embodiments, the system is configured to employ user feedback mechanisms to update the model 121 or the policy 122. In one embodiment, a user may be prompted with an open-ended request for user-specified corrective actions, where the system is configured to perform any action specified by the user in response to such a request. In one embodiment, a user may point to a particular action specified in the policy 122 to be carried out. In some embodiments, the policy specifies which corrective actions do not require user input and can be performed automatically, and which actions require user input.

The example computing system 100 of FIG. 1 is configured to, in addition to suppressing future redundant FFDC artifacts (such as via the performed corrective actions), clean up redundant FFDC artifacts related to the original failure and runaway condition that are stored in disk storage 104. That is, after stopping the runaway condition, the system may subsequently remove unnecessary FFDC artifacts related to the condition that remain in storage. In one embodiment, the policy 122 specifies which FFDC artifacts are to be removed and which artifacts are to be kept in storage. For example, the policy 122 may specify to keep only the first and most recent FFDC artifacts (related to the runaway condition) from each element (such as each actual causing element, or each potential causing element), thereby removing redundant FFDC artifacts associated with each of the elements related to the runaway condition and providing more storage resources for future FFDC artifacts. In such an example, keeping only the first and most recent FFDC artifacts (or memory dumps) allows for further analysis or to preserve the first FFDC artifacts for future use. By cleaning up the disk storage after correcting the FFDC runaway condition, the system is configured to dynamically reducing FFDC resource consumption.

In some embodiments, the system of FIG. 1 is configured to report the actions performed, along with the outcome. For example, after the FFDC module performs the one or more actions to stop or correct the runaway condition, the FFDC module may then generate a report identifying the runaway condition, any actions performed, the status of the system after performing the actions, and the outcome of the actions (such as how each action affected the system or the runaway condition). In some embodiments, the report includes timing information, such as how long after performing each action for the runaway condition to end or be resolved. Such a report may be stored locally within the system, or may be sent to a user. In some embodiments, the model is updated based on the report (either automatically by the model, or manually by a user) to make future responses to runaway conditions more efficient. For example, when determining what actions to perform to alleviate a future FFDC runaway condition, the FFDC module may reference previously stored data associated with previous FFDC runaway conditions that were successfully stopped or corrected. In such an embodiment, when filtering out FFDC artifacts, a criteria considered may include whether or not the workload or subsystem or component (or other FFDC artifact) has caused an FFDC runaway condition before, how recently, how often, how many, and the like. For example, FFDC artifacts that are known to have caused FFDC runaway conditions in the past may not be filtered out in case they are more likely to cause other FFDC runaway conditions.

According to various embodiments of the present disclosure, the computing system 100 of FIG. 1 is configured to dynamically reducing FFDC resource consumption, such as by determining whether these FFDC artifacts are identical or similar in nature, isolating the causing subsystems or elements, and appropriately halting or throttling the FFDC artifact capturing on those subsystems or elements to prevent needless system resource consumption. Additionally, the system is configured for dynamically reducing FFDC resource consumption by carrying out automatic cleanup of the existing FFDC artifacts identified with this runaway condition.

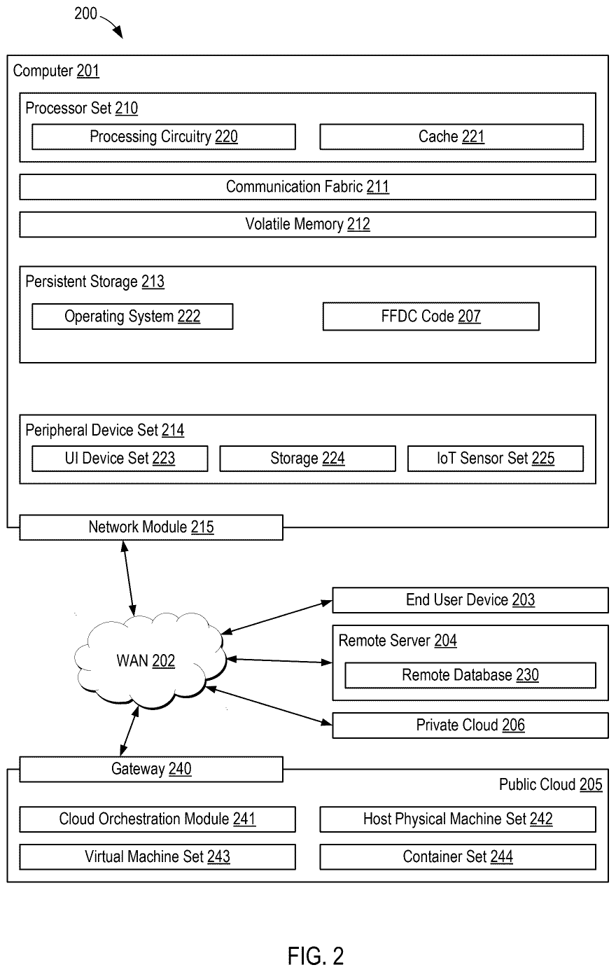

For further explanation, FIG. 2 sets forth a block diagram of computing environment 200 configured for dynamically reducing FFDC resource consumption in accordance with embodiments of the present disclosure. Computing environment 200 contains an example of an environment for the execution of at least some of the computer code involved in performing the inventive methods, such as FFDC code 207 or operating system 222. In addition to FFDC code 207, computing environment 200 includes, for example, computer 201, wide area network (WAN) 202, end user device (EUD) 203, remote server 204, public cloud 205, and private cloud 206. In this example embodiment, computer 201 may include the computing system 100 shown in FIG. 1, and includes processor set 210 (including processing circuitry 220 and cache 221), communication fabric 211, volatile memory 212, persistent storage 213 (including operating system 222 and FFDC code 207, as identified above), peripheral device set 214 (including user interface (UI) device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244. In one embodiment, the FFDC code 207 is included in the FFDC module 114 and is configured to identify the runaway condition, determine the potential and actual causing elements, perform corrective actions, and cleanup the disk storage. In another embodiment, the FFDC code 207 is included within the operating system 222 (e.g., operating system 112 of FIG. 1).

Computer 201 may take the form of a desktop computer, laptop computer, tablet computer, smart phone, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in FFDC code 207 in persistent storage 213.

Communication fabric 211 is the signal conduction path that allows the various components of computer 201 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface-type operating systems that employ a kernel. The code included in FFDC code 207 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215. Network module 215 may be configured to communicate with other systems or devices, such as sensors 225, for receiving sensor measurements.

WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

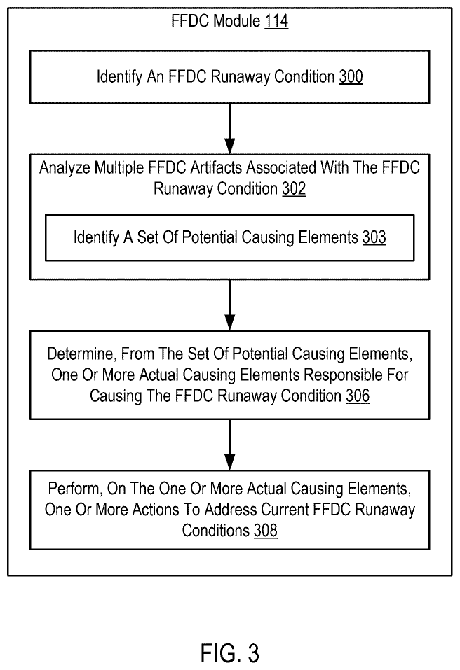

For further explanation, FIG. 3 sets forth a flow chart illustrating an exemplary method of dynamically reducing FFDC resource consumption according to embodiments of the present disclosure. The method of FIG. 3 includes identifying 300 an FFDC runaway condition. Identifying 300 an FFDC runaway condition may be carried out by FFDC module 114 determining that the rate of generated FFDC artifacts (or the rate of artifacts being stored in disk storage) has increased above a threshold amount, indicating a FFDC runaway condition is affecting the system. In one embodiment, the rate is user selected. In another embodiment, the threshold is automatically determined (e.g., by model 121) and specified within policy 122. In one embodiment, the threshold is a system-wide threshold, considering the total rate of stored FFDC artifacts. In another embodiment, the system considers multiple thresholds, where each threshold is associated with a particular element (and the associated FFDC artifacts). For example, some subsystems or components may be expected to have higher FFDC artifact generation rates than others, and thus a threshold (for indicating an FFDC runaway condition) associated with that subsystem will be inherently higher other thresholds associated with other elements. Identifying an FFDC runaway condition also be based on other criteria (whether user specified or model specified within the policy), such as a statistical significance of artifact creation rate and sufficient similarity.

The method of FIG. 3 also includes analyzing 302 multiple FFDC artifacts associated with the FFDC runaway condition. Analyzing 302 multiple FFDC artifacts associated with the FFDC runaway condition may be carried out by FFDC module 114 determining which FFDC artifacts are associated with the identified FFDC runaway condition and analyzing attributes or information associated with each of the FFDC artifacts. In one embodiment, the multiple FFDC artifacts associated with the runaway condition include all FFDC artifacts stored in disk storage after a determined initial time of the FFDC runaway condition. For example, the system may identify the runaway condition and then determine that all subsequent FFDC artifacts generated and stored are associated with the runaway condition. Analyzing the multiple FFDC artifacts associated with the FFDC runaway condition may include determining patterns, similarities, or relationships between the FFDC artifacts. In some embodiments, the analyzing of the artifacts is performed using a machine learning or artificial intelligence model (such as model 121 in FIG. 1). In some embodiments, the analyzing is performed according to a policy, such as policy 122.

The method of FIG. 3 also includes, as part of analyzing the multiple FFDC artifacts associated with the FFDC runaway condition, identifying 303 a set of potential causing elements. Identifying 303 a set of potential causing elements may be carried out by FFDC module 114 determining which elements associated with the multiple FFDC artifacts associated with the condition could be potentially responsible for the runaway condition. In some embodiments, identifying the set of potential causing elements is performed using a machine learning or artificial intelligence model (such as model 121 in FIG. 1). In some embodiments, identifying the set of potential causing elements is performed according to a policy, such as policy 122. Identifying the set of potential causing elements may be based on a number of FFDC artifacts associated with a particular element. For example, an element, such as a subsystem, may be determined to be a potential causing element based on the element having a number of FFDC artifacts (associated with the runaway condition) above a threshold number (where the threshold may be user selected or determined by the model and included within the policy). In another embodiment, a potential causing element may be determined based on a rate of FFDC artifacts generated/stored by the element (based on a threshold rate). For example, an element that stores a significant amount of FFDC artifacts, or stores them at a significant rate, may be a potential causing element.

The method of FIG. 3 also includes determining 306, from the set of potential causing elements, one or more actual causing elements responsible for causing the FFDC runaway condition. Determining 306 one or more actual causing elements responsible for causing the FFDC runaway condition may be carried out by FFDC module 114 performing one or more tests on the potential causing elements to verify whether the potential causing elements are in fact actual causing elements (that is, confirming if a predicted element predicted to be responsible is indeed actually responsible (at least partially) for the runaway condition). In one embodiment, the one or more tests may include disrupting the element and comparing a corresponding FFDC artifact from the disruption with the known other FFDC artifacts to determine a match, thereby verifying that the element is responsible for a number of the FFDC artifacts. In another embodiment, disrupting an element may be carried out to subsequently determine whether disrupting the element improved the condition (decreased the rate or number of FFDC artifacts associated with the runaway condition).

The method of FIG. 3 also includes performing 308, on the one or more actual causing elements, one or more actions to address current FFDC runaway conditions. Performing 308 one or more actions to address current FFDC runaway conditions may be carried out by FFDC module 114 referencing the policy (such as policy 122) and carrying out one or more specified actions within the system (such as on one or more of the actual causing elements) in order to slow down and stop the runaway condition within the system. For example, the FFDC module may restart the subsystems or elements determined as actual causing elements in order to correct and stop the runaway condition from the continuing. In some embodiments, the one or more actions may be performed automatically. In another embodiment, one or more actions to be performed may require user input to be performed. In one embodiment, the policy is updated based on feedback after performing the one or more actions. For example, after performing the one or more actions, where some of the actions were more effective than others, a policy may be updated to, in the future, only perform the most effective actions, or to no longer perform actions that were deemed ineffective. In some embodiments, the model is configured to update the policy based on performing the one or more actions. By performing one or more actions (corrective actions), the FFDC module 114 is configured to stop the runaway condition from continuing, thereby reducing FFDC resource consumption.

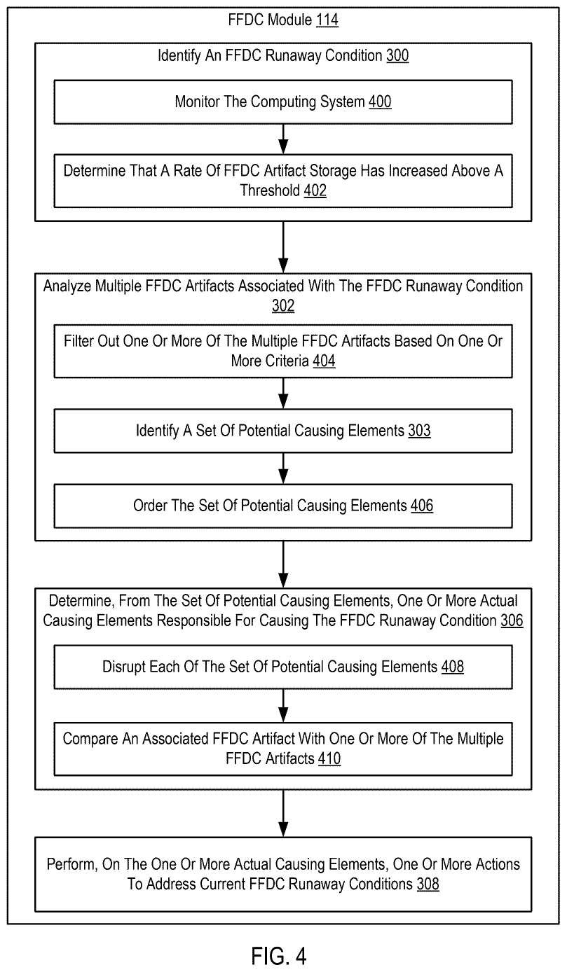

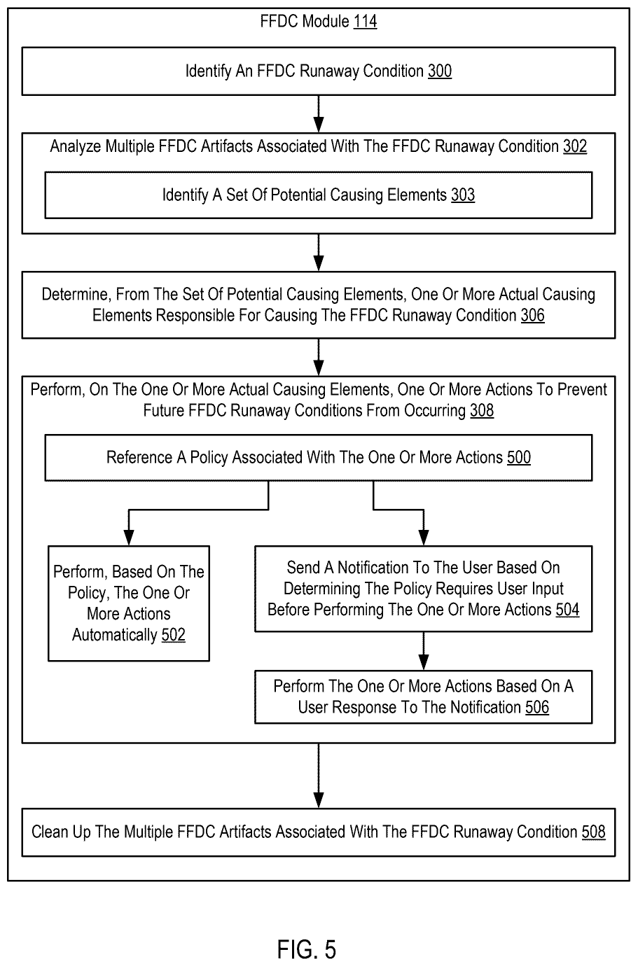

For further explanation, FIG. 4 sets forth a flow chart illustrating another exemplary method of dynamically reducing FFDC resource consumption according to embodiments of the present disclosure. The method of FIG. 4 differs from the method of FIG. 3 in that the method of FIG. 4 further includes, as part of identifying 300 an FFDC runaway condition, monitoring 400 the computing system. Monitoring 400 the computing system may be carried out by FFDC module 114 observing the disk storage and the FFDC artifacts generated or stored within it in order to determine when an FFDC runaway condition starts to occur. In one embodiment, monitoring the computing system includes monitoring the entire system, including each of the elements within the system, for FFDC artifact generation. In some embodiments, monitoring and subsequent steps (included in FIG. 4 or 5) may be performed in parallel. In some embodiments, FFDC artifacts may be grouped or clustered based on various additional metadata such as component/product relationships, dependencies, and interactions.

The method of FIG. 4 also includes, as part of identifying 300 an FFDC runaway condition, determining 402 that a rate of FFDC artifact storage has increased above a threshold. Determining 402 that a rate of FFDC artifact storage has increased above a threshold may be carried out by FFDC module 114 referencing a policy (such as policy 122 of FIG. 1) for a threshold and comparing the FFDC artifacts being generated, in real time, with the threshold. In one embodiment, the threshold is a total system-wide FFDC artifact generation rate. In such an embodiment, a runaway condition is identified if the FFDC module determines that the rate of FFDC artifact generation (or storage rate within the disk storage) for the whole system has increased to above the threshold. In another embodiment, the system may include multiple threshold rates for each element, or for one or more groups of elements. In another embodiment, the threshold for determining a runaway condition may be a rate of increase of the rate of FFDC artifact generation. That is, identifying the runaway condition may be based on how fast the rate of FFDC artifact generation increases.

The method of FIG. 4 also includes, as part of analyzing 302 multiple FFDC artifacts associated with the FFDC runaway condition, filtering 404 out one or more of the multiple FFDC artifacts based on one or more criteria. Filtering 404 out one or more of the multiple FFDC artifacts based on one or more criteria may be carried out by FFDC module 114 parsing through all of the FFDC artifacts associated with the runaway condition and determining which artifacts are not related to elements that could be potential causing elements. That is, after filtering out artifacts, any artifacts left over after the filtering process may be associated with a potential causing element. In one embodiment, the one or more criteria includes an error severity level, an associated subsystem (or an importance level corresponding with the associated subsystem), or an associated workload being executed (or an importance level corresponding with the associated workload being executed). For example, FFDC artifacts that do not meet a sufficient severity level (i.e., are low-level informational error codes) may be filtered out. In some embodiments, filtering 404 out one or more of the multiple FFDC artifacts is performed using a machine learning or artificial intelligence model (such as model 121 in FIG. 1). In some embodiments, the filtering is performed according to a policy, such as policy 122. In one embodiment, filtering includes identifying FFDC artifacts that have previously impacted the system (which may include using a simple binary classifier or a time series analysis).

The method of FIG. 4 also includes, as part of analyzing 302 multiple FFDC artifacts associated with the FFDC runaway condition, ordering 406 the set of potential causing elements. Ordering 406 the set of potential causing elements may be carried out by FFDC module 114 assigning a rank or order to each of potential causing elements identified within the set, thereby ordering the potential causing elements from most likely to be at least partially responsible for the runaway condition to least likely. That is, ordering the set of potential causing elements may include assigning a confidence level to each potential causing element. Ordering the elements may be carried out based on one or more criteria. In one embodiment, the set of potential causing elements may be ordered based on a number of error counts (or artifact counts associated with the runaway condition), where the elements having a highest number of artifacts associated with the runaway condition listed first. In another embodiment, the set of potential causing elements may be ordered based on an error severity level (the severity level associated with the failure for each artifact by a given element). For example, elements experiencing more severe failures or errors (which may be indicated within each FFDC artifact) may be listed first within the ordered set. In some embodiments, the ordering may be based on multiple criteria at once, such as the number of artifacts, an error severity level, or may be some weighted combination of the two. In some embodiments, ordering 406 the set of potential causing elements is performed using a machine learning or artificial intelligence model (such as model 121 in FIG. 1). In some embodiments, the ordering is performed according to a policy, such as policy 122.

The method of FIG. 4 also includes, as part of determining 306, from the set of potential causing elements, one or more actual causing elements responsible for causing the FFDC runaway condition, disrupting 408 each of the set of potential causing elements. Disrupting 408 each element of the set of potential causing elements may be carried out by FFDC module 114 referencing a policy and disrupting the elements according to the policy. In one embodiment, disrupting the potential causing elements is performed serially (one at a time) and according to the order (see 406 of FIG. 4) of the set. The FFDC module is configured to disrupt each potential causing element (e.g., component, process, subsystem, or address space) from most likely to least likely, to determine if the disruption has caused a statistically significant change in artifact creation, thereby verifying whether a given potential causing element is actually a cause of the runaway condition, as predicted. Disrupting may include interrupting, or temporarily halting, an element. For example, in some embodiments, the disruption may include restarting the element (such as a subsystem), or causing a delay.

In one embodiment, each element is disrupted multiple times periodically to confirm that the disruption of the element positively impacts the runaway condition (such as decreasing the rate of FFDC artifacts being stored in disk storage). In one embodiment, serially disrupting the potential causing elements is carried out until all of the potential causing elements in the set have been disrupted. In another embodiment, serially disrupting the potential causing elements is carried out only until a previously determined number of actual causing elements have been confirmed, or until a predetermined percentage of the FFDC runaway condition has been affected or stopped. In one embodiment, the system is configured to skip over (and thereby prevent disrupting) an element if it is critical to a particular workload or application. Such elements may be determined based on the policy 122. In another embodiment, protecting critical or important workloads or applications may be carried out by skipping over such associated elements when determining the one or more actual causing elements, which protects the workloads earlier in the process. Such workloads or applications may be specified in the policy, indicated to skip over disrupting associated elements when addressing FFDC runaway conditions. In some embodiments, disrupting 408 each of the set of potential causing elements is performed using a machine learning or artificial intelligence model (such as model 121 in FIG. 1). In some embodiments, disrupting 408 each of the set of potential causing elements is performed according to a policy, such as policy 122.

The method of FIG. 4 also includes, as part of determining 306, from the set of potential causing elements, one or more actual causing elements responsible for causing the FFDC runaway condition, comparing 410 an associated FFDC artifact with one or more of the multiple FFDC artifacts. Comparing 410 an associated FFDC artifact with one or more of the multiple FFDC artifacts may be carried out by FFDC module 114 verifying that an expected FFDC artifact associated with the disruption matches one or more of the known multiple FFDC artifacts associated with the runaway condition. Such a verification indicates that the potential causing element is an actual causing element, due to confirming that the element is in fact responsible for a number of the FFDC artifacts associated with the runaway condition. In one embodiment, such a comparison is performed in parallel with serially disrupting each of the potential causing elements.

For further explanation, FIG. 5 sets forth a flow chart illustrating another exemplary method of dynamically reducing FFDC resource consumption according to embodiments of the present disclosure. The method of FIG. 5 differs from the method of FIG. 3 in that the method of FIG. 5 further includes, as part of performing 308, on the one or more actual causing elements, one or more actions to address current FFDC runaway conditions, referencing 500 a policy associated with the one or more actions. Referencing 500 a policy associated with the one or more actions may be carried out by FFDC module 114 accessing the policy (such as the policy 122 stored in RAM in computing system 100. In some embodiments, the policy is stored local to the FFDC module (as shown in FIG. 1). In other embodiments, the policy is stored outside of the FFDC module. Such a policy may include information and instructions for how to perform each of the steps included in this disclosure and included in FIGS. 3-5. In some embodiments, the policy may include one or more actions associated with every element to perform in response to that element being associated with an FFDC runaway condition. In some embodiments, the policy may indicate an order in which to perform the one or more actions (or other instructions), as well as parameters with each action indicating whether or not each action may be performed automatically or after receiving user input. By referencing 500 the policy in FIG. 5, the FFDC module may determine how to proceed with performing the one or more corrective actions to stop and correct the current runaway condition, and also to prevent future FFDC runaway conditions from occurring.

The method of FIG. 5 also includes, as part of performing 308 one or more actions, performing 502, based on the policy, the one or more actions automatically. Performing 502, based on the policy, the one or more actions automatically may be carried out by FFDC module 114 identifying which actions indicated in the policy may be carried out automatically, and proceeding to automatically (without user input) perform those actions. Such actions may be performed immediately responsive to referencing the policy. For example, upon referencing the policy and determining that the policy indicates an action to be performed automatically for a subsystem (or other element) identified as an actual causing element, the FFDC module may proceed by performing the action automatically without user input. In some embodiments, a machine learning or artificial intelligence model (such as model 121) is configured to determine which one or more actions will be performed.

The method of FIG. 5 also includes, as part of performing 308 one or more actions, sending 504 a notification to the user based on determining the policy requires user input before performing the one or more actions. Sending 504 a notification to the user based on determining the policy requires user input before performing the one or more actions may be carried out by FFDC module 114 identifying which actions indicated in the policy require user input (where the policy is configured to also indicate what type of user input is required), and proceeding to send a notification to the user. In some embodiments, the notification may identify the one or more actions to be performed, the one or more actual causing elements associated with those actions, and which actions require permission (and what type of permission). In one embodiment, the notification may merely request permission or approval for performing the indicated one or more actions. For example, the FFDC module may reference the policy and send a notification to a user (such as a system admin) asking for permission to restart a particular application. In another embodiment, the notification may be an open-ended request for a user to specify which actions to perform, or may provide a list of possible actions and request which ones the user permits to move forward with. In some embodiments, actions may be performed automatically (such as in step 502) simultaneously with sending a notification (step 504) to the user for performing additional actions. In one embodiment, performing the one or more actions includes determining whether the runaway condition matches a definition in the policy, and determining which actions to perform (and whether they are to be performed automatically) based on the definition in the policy. In some embodiments, the notification is sent to the user responsive to determining that no matching definition is included in the policy.

The method of FIG. 5 also includes, as part of performing 308 one or more actions, performing 506 the one or more actions based on a user response to the notification. Performing 506 the one or more actions based on a user response to the notification may be carried out by FFDC module 114 receiving a user response to the notification and performing the one or more actions indicated in the response. In one embodiment, the response may indicate approval for one or more actions. In another embodiment, the response may include an instruction to perform one or more actions responsive to an open-ended notification. In some embodiments, the indicated actions included in the response may reference the policy.

The method of FIG. 5 also includes cleaning 508 up the multiple FFDC artifacts associated with the FFDC runaway condition. Cleaning 508 up the multiple FFDC artifacts associated with the FFDC runaway condition may be carried out by FFDC module 114 removing redundant FFDC artifacts related to the runaway condition that are stored in disk storage 104. The cleanup of disk storage may be performed simultaneously with performing 308 the one or more actions, or afterwards. In one embodiment, the policy 122 specifies which FFDC artifacts are to be removed and which artifacts are to be kept in storage. For example, the policy 122 may specify to keep only the first and last (most recent) FFDC artifacts from each element, thereby removing redundant FFDC artifacts associated with each of the elements related to the runaway condition and providing more storage resources for future FFDC artifacts. In such an example, keeping only the first and most recent FFDC artifacts allows for further analysis or to preserve the first FFDC artifacts for future use. By cleaning up the disk storage after correcting the FFDC runaway condition, the system is configured to dynamically reducing FFDC resource consumption.

In view of the explanations set forth above, readers will recognize that the benefits of dynamically reducing FFDC resource consumption according to embodiments of the present disclosure include:
Increasing system performance by reducing unnecessary resource consumption during FFDC runaway conditions.
Increasing system health by dynamically and automatically identifying, responding to, and correcting, FFDC runaway conditions.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of dynamically reducing first failure data capture (FFDC) resource consumption, the method comprising:
identifying an FFDC runaway condition in a computing system;
analyzing a plurality of FFDC artifacts associated with the FFDC runaway condition, including identifying a set of potential causing elements, wherein the set of potential causing elements include a plurality of elements potentially responsible for causing the FFDC runaway condition;
determining, from the set of potential causing elements, one or more actual causing elements responsible for causing the FFDC runaway condition; and
performing, on the one or more actual causing elements, one or more actions to address current FFDC runaway conditions.

2. The method of claim 1, wherein identifying the FFDC runaway condition includes monitoring the computing system and determining that a rate of FFDC artifact storage has increased above a threshold.

3. The method of claim 1, wherein analyzing the plurality of FFDC artifacts associated with the FFDC runaway condition includes filtering out one or more of the plurality of FFDC artifacts based on one or more criteria.

4. The method of claim 3, wherein the one or more criteria includes at least one of: an error severity level, an associated subsystem, or an associated workload being executed.

5. The method of claim 1, wherein analyzing the plurality of FFDC artifacts associated with the FFDC runaway condition is carried out by one of a machine learning model or an artificial intelligence model.

6. The method of claim 1, further comprising, responsive to identifying the set of potential causing elements, ordering the set of potential causing elements based on one or more of: a number of error counts, or an error severity level.

7. The method of claim 1, wherein determining the one or more actual causing elements includes disrupting each of the set of potential causing elements and comparing an associated FFDC artifact with one or more of the plurality of FFDC artifacts.

8. The method of claim 7, wherein disrupting each of the set of potential causing elements is performed serially based on an ordering of the set of potential causing elements.

9. The method of claim 1, wherein the one or more actions to address current FFDC runaway conditions are performed, based on referencing a policy, automatically by the computing system.

10. The method of claim 1, wherein performing the one or more actions includes sending a notification to a user and performing the one or more actions responsive to receiving, from the user, a response to the notification.

11. The method of claim 1, further comprising cleaning up the plurality of FFDC artifacts associated with the FFDC runaway condition.

12. A system for dynamically reducing first failure data capture (FFDC) resource consumption, the system comprising:
a disk storage configured for storing FFDC artifacts;
one or more subsystems configured to store FFDC artifacts in the disk storage; and
a processor configured to monitor the disk storage, wherein the processor is configured to:
identify an FFDC runaway condition;
analyze a plurality of FFDC artifacts stored in the disk storage and associated with the FFDC runaway condition, including identifying a set of potential causing elements, wherein the set of potential causing elements include a plurality of elements potentially responsible for causing the FFDC runaway condition;
determine, from the set of potential causing elements, one or more actual causing elements responsible for causing the FFDC runaway condition; and
perform, on the one or more actual causing elements, one or more actions to address current FFDC runaway conditions.

13. The system of claim 12, wherein analyzing the plurality of FFDC artifacts associated with the FFDC runaway condition includes filtering out one or more of the plurality of FFDC artifacts based on one or more criteria.

14. The system of claim 13, wherein the one or more criteria includes at least one of: an error severity level, an associated subsystem, or an associated workload being executed.

15. The system of claim 12, further comprising, responsive to identifying the set of potential causing elements, ordering the set of potential causing elements based on one or more of: a number of error counts, or an error severity level.

16. The system of claim 12, wherein determining the one or more actual causing elements includes disrupting each of the set of potential causing elements and comparing an associated FFDC artifact with one or more of the plurality of FFDC artifacts.

17. The system of claim 16, wherein disrupting each of the set of potential causing elements is performed serially based on an ordering of the set of potential causing elements.

18. A computer program product comprising a computer readable storage medium and computer program instructions stored therein that, when executed, are configured to:
identify an FFDC runaway condition;
analyze a plurality of FFDC artifacts associated with the FFDC runaway condition, including identifying a set of potential causing elements, wherein the set of potential causing elements include a plurality of elements potentially responsible for causing the FFDC runaway condition;
determine, from the set of potential causing elements, one or more actual causing elements are responsible for causing the FFDC runaway condition; and
perform, on the one or more actual causing elements, one or more actions to address current FFDC runaway conditions.

19. The computer program product of claim 18, wherein analyzing the plurality of FFDC artifacts associated with the FFDC runaway condition includes filtering out one or more of the plurality of FFDC artifacts based on one or more criteria.

20. The computer program product of claim 18, wherein determining the one or more actual causing elements includes disrupting each of the set of potential causing elements and comparing an associated FFDC artifact with one or more of the plurality of FFDC artifacts.
